(19) United States
(12) Patent Application Publication
(10) Pub. No.: US 2024/0193758 A1
(43) Pub. Date: Jun. 13, 2024

(54) APPARATUS AND METHOD WITH IMAGE GENERATION

(71) Applicant: Samsung Electronics Co., Ltd., Suwon-si (KR)

(72) Inventors: Prashant Pandurang SHINDE, Bengaluru (IN); Shashishekara Parampalli ADIGA, Bengaluru (IN); Priyadarshini Panemangalore PAI, Bengaluru (IN)

(73) Assignee: Samsung Electronics Co., Ltd., Suwon-si (KR)

(21) Appl. No.: 18/500,629

(22) Filed: Nov. 2, 2023

(30) Foreign Application Priority Data
Dec. 8, 2022 (IN) 202241070905
Jun. 1, 2023 (KR) 10-2023-0070977

(51) Int. Cl. G06T 7/00; G06T 7/11; G06T 7/62; G06V 10/70

(52) U.S. Cl. CPC G06T 7/0008; G06T 7/11; G06T 7/62; G06V 10/70; G06T 2207/10061; G06T 2207/30148; G06V 2201/07

(57) ABSTRACT

A processor-implemented method with image generation includes: receiving a plurality of input parameters for a plurality of images to be generated; generating a plurality of defect profiles comprising a size and location of one or more defects to be formed in an image; and generating the plurality of images comprising defect information based on the plurality of defect profiles and the plurality of input parameters using an image rendering operation.

### CROSS-REFERENCE TO RELATED APPLICATIONS

This application claims the benefit under 35 USC § 119(a) of Indian Patent Application No. 202241070905 filed on Dec. 8, 2022, in the Indian Patent Office, and Korean Patent Application No. 10-2023-0070977 filed on Jun. 1, 2023, in the Korean Intellectual Property Office, the entire disclosures of which are incorporated herein by reference for all purposes.

### BACKGROUND

### 1. Field

The following description relates to an apparatus and method with image generation.

### 2. Description of Related Art

One of the processes of manufacturing integrated circuit (IC) chips is a patterning process, in which a unique design may be printed on a semiconductor wafer surface to form patterns of ICs. The patterning process may be followed by an inspection to check for any defects in the formed patterns. The inspection may be performed by capturing an image of a semiconductor wafer using a scanning electron microscope (SEM) and manually checking for defects. Furthermore, the inspection may be performed to identify and fix the defects that, if not rectified, may affect the yield and quality of IC chips.

There are various limitations associated with the current technique of inspecting patterns. For instance, when the inspection is performed by selecting randomly a wafer sample and manually inspecting an image of the wafer sample using the SEM for defects, the manual inspection of the wafer may be a time-intensive activity and prone to human errors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with image generation includes: receiving a plurality of input parameters for a plurality of images to be generated; generating a plurality of defect profiles comprising a size and location of one or more defects to be formed in an image; and generating the plurality of images comprising defect information based on the plurality of defect profiles and the plurality of input parameters using an image rendering operation.

The plurality of input parameters may include one or more of a plurality of defects to be formed in each image and a plurality of defect types.

The generating of the plurality of images may include generating the plurality of images such that a total number of defects of each type, from among a plurality of defect types, is inserted in equal numbers in the plurality of generated images.

Each of the plurality of generated images may include a line pattern corresponding to either one of an optical microscopy image and a scanning electron microscope image of a patterning process.

One or more defects of the line pattern may include any one or any combination of any two or more of a micro bridge, a bridge, a micro gap, an extended gap, and a line-collapse.

The generating of the plurality of defect profiles may include determining the location and size of the one or more defects to be formed in each image to be formed using a random distribution operation.

The method may include: providing the plurality of generated images and the plurality of generated defect profiles as a training data set to train a machine learning model; processing each image of the plurality of images into a grid comprising a plurality of cells; identifying an object by processing each cell in the grid using an object detection operation; and training the machine learning model by comparing coordinates of the identified object with coordinates stored in the plurality of generated defect profiles.

The method may include: providing a real image of a semiconductor wafer after a patterning process; and identifying the one or more defects in the real image using the trained machine learning model.

The identifying of the one or more defects in the real image using the trained machine learning model may include determining any one or any combination of any two or more of a defect type, a defect size, and a defect location in the real image.

In one or more general aspects, a non-transitory computer-readable storage medium stores instructions that, when executed by a processor, configure the processor to perform any one, any combination, or all of operations and/or methods described herein.

In one or more general aspects, an apparatus with image generation includes: one or more processors configured to: receive a plurality of input parameters for a plurality of images to be generated; generate a plurality of defect profiles comprising a size and location of one or more defects to be formed in an image; and generate the plurality of images comprising defect information based on the plurality of defect profiles and the plurality of input parameters using an image rendering operation.

The plurality of input parameters may include one or more of a plurality of defects to be formed in each image and a plurality of defect types.

For the generating of the plurality of images, the one or more processors may be configured to generate the plurality of images such that a total number of defects of each type, from among a plurality of defect types, is inserted in equal numbers in the plurality of generated images.

Each of the plurality of generated images may include a line pattern corresponding to either one of an optical microscopy image and a scanning electron microscope image of a patterning process.

One or more defects of the line pattern may include any one or any combination of any two or more of a micro bridge, a bridge, a micro gap, an extended gap, and a line-collapse.

For the generating of the plurality of defect profiles, the one or more processors may be configured to determine the location and size of the one or more defects to be formed in each image to be formed using a random distribution operation.

The one or more processors may be configured to: receive the plurality of generated images and the plurality of generated defect profiles as a training data set to train a machine learning model; process each image of the plurality of images into a grid comprising a plurality of cells; identify an object by processing each cell in the grid using an object detection operation; and train the machine learning model by comparing coordinates of the identified object with coordinates stored in the plurality of generated defect profiles.

The one or more processors may be configured to: receive a real image of a semiconductor wafer after a patterning process; and identify the one or more defects in the real image using the trained machine learning model.

For the identifying of the one or more defects in the real image using the trained machine learning model, the one or more processors may be configured to determine any one or any combination of any two or more of a defect type, a defect size, and a defect location in the real image.

In one or more general aspects, a processor-implemented method with image generation includes: processing each of a plurality of generated images into a grid comprising a plurality of cells, wherein the plurality of images are generated based on a plurality of defect profiles and a plurality of input parameters using an image rendering operation; identifying an object by processing each cell in the grid using an object detection operation; and training a machine learning model by comparing coordinates of the identified object with coordinates stored in the plurality of defect profiles.

Other features and aspects will be apparent from the following detailed description, the drawings, and the claims.

### BRIEF DESCRIPTION OF THE DRAWINGS

FIG. 1 illustrates an example of an apparatus for generating an image with a defect.

FIG. 2 illustrates an example of a plurality of generated images with multiple defects in an apparatus.

FIG. 3 illustrates an example of a pair of generated images blurred using a gaussian blur in an apparatus.

FIG. 4 illustrates an example of a process of generating a plurality of images each having at least one defect in an apparatus.

FIG. 5 illustrates an example of a process of training a machine learning model in an apparatus.

FIG. 6 illustrates an example of a process of identifying a defect in a real image using a trained machine learning model in an apparatus.

FIG. 7 illustrates an example of a schematic configuration of an image generation apparatus for generating an image with a defect.

FIG. 8 illustrates an example of a schematic configuration of a detection apparatus for training a machine learning model that identifies a defect and detecting a defect using the machine learning model.

Throughout the drawings and the detailed description, unless otherwise described or provided, it may be understood that the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Hereinafter, examples will be described in detail with reference to the accompanying drawings. However, various alterations and modifications may be made to the examples. Here, the examples are not meant to be limited by the descriptions of the present disclosure. The examples should be understood to include all changes, equivalents, and replacements within the idea and the technical scope of the disclosure.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms including technical and scientific terms used herein have the same meaning as commonly understood by one of ordinary skill in the art to which this disclosure pertains and based on an understanding of the disclosure of the present application. Terms defined in dictionaries generally used should be construed to have meanings matching with contextual meanings in the related art and are not to be construed as having an ideal or excessively formal meaning unless otherwise defined herein.

When describing the examples with reference to the accompanying drawings, like reference numerals refer to like components and a repeated description related thereto will be omitted. In the description of examples, detailed description of well-known related structures or functions will be omitted when it is deemed that such description will cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning. The use of the term “may” herein with respect to an example or embodiment, e.g., as to what an example or embodiment may include or implement, means that at least one example or embodiment exists where such a feature is included or implemented, while all examples are not limited thereto.

Components included in an example and components having a common function are described using the same names in other examples. Unless otherwise mentioned, the descriptions of the examples may be applicable to the following examples and thus, duplicated descriptions will be omitted for conciseness.

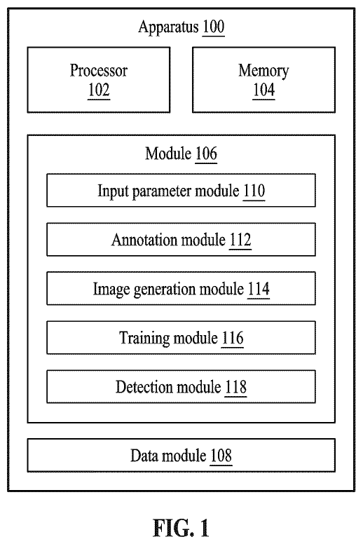

According to examples of the present disclosure, an apparatus and method with image generation will be described in detail below with reference to FIGS. 1 to 8.

FIG. 1 illustrates an example of an apparatus 100 for generating an image with a defect.

Referring to FIG. 1, the apparatus 100 may be a part of an environment configured to inspect the quality of a manufactured integrated circuit (IC), such as system-on-chip (SoC). In an example, the apparatus 100 may be configured to inspect a patterning process/step of IC manufacturing. The patterning process is a process of depositing a conductive material on a substrate, such as a semiconductor wafer, to form an electronic circuit. The patterning process may include a process of depositing the conductive material in a pattern on a nanometric scale. During the patterning process, the deposition of a material may not be uniform, resulting in a defect on a wafer. The defect may be an inconsistency in a pattern formed during the patterning process. Such defect types of a line pattern may include, but are not limited to, a micro bridge, a bridge, a micro gap, an extended gap, and a line-collapse.

The apparatus 100 may be configured to generate a synthetic image with a defect added to the synthetic image, such that the number of each defect types across all generated images is equal or in equivalent numbers.

The apparatus 100 may also be configured to annotate defects in the generated images and use the defects as a training data set to train a machine learning model. A synthetic image may be an artificial image of an image of a semiconductor wafer captured using an optical microscope or a scanning electron microscope (SEM). In addition, when the apparatus 100 of one or more embodiments generates the images such that the generated images have the same number of defect types, the machine learning model may be trained to identify all the defect types equally. Furthermore, when the apparatus 100 of one or more embodiments trains the machine learning model to identify all the defect types equally, the trained machine learning model may accurately identify a defect in a real semiconductor image, improving the quality of inspection. As a result, the apparatus 100 of one or more embodiments may precisely detect defects during an automatic inspection process using the machine learning model.

The apparatus 100 may include various components that operate synergistically to generate an image. For example, the apparatus 100 may include a processor 102 (e.g., one or more processors), a memory 104 (e.g., one or more memories), a module 106, and data module 108. In an example, the memory 104 may store instructions to perform operations of the module 106. The module 106 and the memory 104 may be coupled to the processor 102.

The processor 102 may be a single processor or a plurality of processors, all of which may include a plurality of computing modules. The processor 102 may be implemented as one or more microprocessors, microcomputers, microcontrollers, digital signal processors, central processing units (CPUs), state machines, logic circuits, and/or any devices that process signals based on operational instructions. Among other functions, the processor 102 may be configured to retrieve and execute computer-readable instructions and data stored in the memory 104. The processor 102 may include one or a plurality of processors. The one or the plurality of processors may be a general-purpose processor such as a CPU and an application processor (AP), a graphics-only processing unit, such as a graphics processing unit (GPU) and a visual processing unit (VPU), and/or an artificial intelligence (AI)-dedicated processor, such as a neural processing unit (NPU). The one or the plurality of processors may control the processing of input data based on a predefined operation rule or an AI model stored in a non-volatile memory and a volatile memory. The predefined operation rule or the machine learning model may be provided through training or learning.

The memory 104 may include any transitory computer-readable medium known to a person in the art including, for example, a volatile memory, such as static random-access memory (SRAM) and dynamic random-access memory (DRAM), and/or a non-volatile memory, such as read-only memory (ROM), erasable programmable read-only memory (EEPROM), a flash memory, a hard disk, an optical disk, and magnetic tape.

The module 106, among other things, may implement routines, programs, objects, components, data structures, and the like that perform predetermined tasks or implement data types. The module 106 may also be implemented as a signal processor and/or any other device or component that manipulates signals based on operational instructions.

In addition, the module 106 may be hardware, e.g., hardware implementing instructions. The module 106 may include a processor or any other suitable devices capable of processing instructions. The processor may be a general-purpose processor that executes instructions to cause the general-purpose processor 102 to perform required tasks, or the processor may be dedicated to performing required functions. In another example of the present disclosure, the module 106 may store machine-readable instructions (software) which, when executed by the processor 102, perform any of the described functions. In addition, the data module 108 serves, among other things, as a repository for storing data processed, received, and generated by one or more modules 106. The data module 108 may store information and/or instructions for performing activities by the processor 102.

The module 106 may perform different functions which may include, but may not be limited to, receiving information to generate an image. Accordingly, the module 106 may include an input parameter module 110, an annotation module 112, an image generation module 114, a training module 116, and a detection module 118. At least one of the plurality of modules (e.g., 110, 112, 114, 116, and 118) may be implemented through a machine learning model. A function associated with AI may be performed through the non-volatile memory, the volatile memory, and the processor 102.

In an example, the input parameter module 110 may be configured to receive a plurality of input parameters from a user. The input parameters may be a plurality of images to be formed, a plurality of defects to be formed in each image, and/or a plurality of defect types to be formed in each image, but examples are not limited thereto. These details are provided to ensure that defects in generated images represent the occurrence of defects in a large number of scenarios during the patterning process. In addition, the input parameters may include the size of an image to be formed, the resolution of the image to be formed, and blur, if determined, to be introduced in the image. By processing such input parameters, the apparatus 100 of one or more embodiments may generate an image that looks identical or more similar to a real image of a semiconductor wafer and the apparatus 100 of one or more embodiments may train the machine learning model to effectively identify a defect in the real image. Moreover, by generating an image that looks similar to a real image, the apparatus 100 of one or more embodiments may not require processing of the real image such that the real image is compatible with detection by the machine learning model, as required by a typical apparatus. In an example, the input parameter module 110 may compare all such input parameters before sharing the parameters with the image generation module 114.

In an example, the annotation module 112 may be communicatively coupled to the input parameter module 110 and may be configured to generate a plurality of defect profiles that may be used by the image generation module 114 to generate an image. In an example, the annotation module 112 may generate a defect profile for each image to be generated. In addition, the number of defect profiles generated by the annotation module 112 may be based on the number of images that the user desires the apparatus 100 to generate. For example, the annotation module 112 may generate 10,000 defect profiles corresponding to 10,000 images to be generated by the apparatus 100.

The annotation module 112 may determine a location of a defect using the above-mentioned input parameters and a random distribution technique to generate a defect profile. The random distribution technique may be a statistical technique that enables the annotation module 112 to generate a location of a defect to be formed. Furthermore, when a plurality of defects is formed, the annotation module 112 may determine a location of each of the defects to be generated. In addition to the location of a defect, the annotation module 112 may determine the number of defects to be formed in an image. In an example, the annotation module 112 may determine the number of defects using the random distribution technique. As a result, when the user provides the number of defects in an image, the annotation module 112 may automatically determine the number of defects and insert their locations into the image.

The location and size of a defect may be in a form of coordinates that the image generation module 114 may interpret. In an example, coordinates may be cartesian coordinates corresponding to a surface of an image. The annotation module 112 may also convert generated coordinates into pixel coordinates corresponding to locations of pixels of an image. Through this conversion, the image generation module 114 may efficiently insert a defect into an image to be generated. The converted coordinates of the location and size of the defect may be provided to the themage generation module 112 as a defect profile.

The generation of the location/number of defects to generate a defect profile may be referred to as annotation of a defect. In addition, the apparatus 100 of one or more embodiments may automatically perform the annotation of a defect without manual intervention. Therefore, the apparatus 100 of one or more embodiments may prevent human errors from being made when a defect profile is generated. Moreover, through automatic annotation, the apparatus 100 of one or more embodiments may ensure that defect profiles of a large number of scenarios for the location and number of defects are generated for robust training of the machine learning model.

In an example, the image generation module 114 may operably communicate with the input parameter module 110 and the annotation module 112. The image generation module 114 may be adjusted to generate a plurality of images based on an associated defect profile and the input parameters. The image generation module 114 may generate an image by applying an image rendering technique. In addition, the image generation module 114 may generate an image by implementing a ray tracing technique. In an example, the image generation module 114 may identify parameters for which an image is to be generated by processing a defect profile. The image generation module 114 may parse an individual defect profile to determine parameters for images to be generated and generate the images accordingly. In an example, each of the plurality of generated images may include a line pattern corresponding to one of an optical microscopy image and an SEM image of a patterning process.

In an example, the image generation module 114 may process the images such that the images look identical or more similar to a real image.

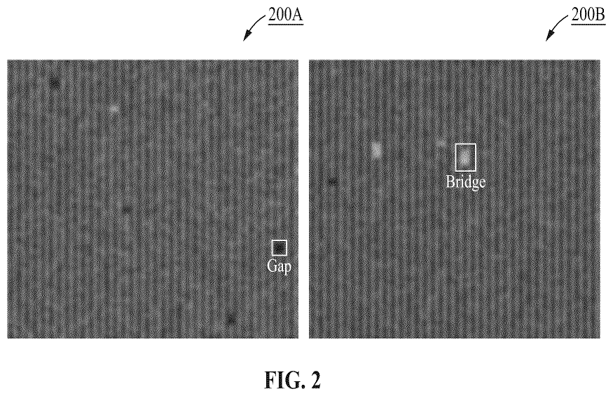

FIG. 2 illustrates an example of a plurality of generated images with multiple defects in an apparatus.

Referring to FIG. 2, the image generation module 114 may blur images 200A and 200B such that the images look identical or more similar to an image captured using an SEM. Therefore, when the apparatus 100 of one or more embodiments trains a machine learning model, the trained machine learning model may easily process a real image. In addition, the image generation module 114 may connect generated images to corresponding defect profiles.

When the images (e.g., the blur images 200A and 200B) are generated, the apparatus 100 may then train the machine learning model. Particularly, the training module 116 may train the machine learning model using the generated images and the defect profiles. The training module 116 may be communicatively coupled to the image generation module 114 and the annotation module 112. In an example, the training module 116 may receive the generated images from the image generation module 114 and receive the defect profiles from the annotation module 112. The machine learning model trained by the training module 116 may be a supervised learning model and/or an unsupervised learning model. In addition, the training module 116 may be provided through a learning means.

Here, the meaning of being provided through learning means is that, by applying a learning technique to a plurality of training data sets, a predefined operation rule or a machine learning model of desired characteristics is created. The learning may be performed by an apparatus itself in which the machine learning model is performed and implemented by a separate server/system. The learning may be performed by the apparatus 100 and the implementation of the learned model may also be performed by the apparatus 100.

The machine learning model may include a plurality of neural network layers. Each layer may have a plurality of weight values and may perform a layer operation through calculation of a previous layer and a plurality of weight operations. Examples of a neural network may be a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network. However, examples are not limited thereto.

The learning technique may be a technique of causing, allowing, or controlling a target device to perform determination or prediction by training a predetermined target device (e.g., a robot) by using a plurality of pieces of training data. Examples of the learning technique may include supervised learning, unsupervised learning, semi-supervised learning, or reinforcement learning. However, examples are not limited thereto.

In an example, the training module 116 may select one image from among the plurality of generated images and corresponding defect profiles. Thereafter, the training module 116 may divide the image into a grid. The training module 116 may then refer to the defect profiles to determine pixel coordinates of the location and size of a defect. The training module 116 may then identify an object in the grid by applying an object detection technique to each cell in the grid. Furthermore, the training module 116 may identify coordinates of the object found in one of the grids and compare the coordinates of the identified object with coordinates of a defect profile. When the degree to which the coordinates of the detected object and the coordinates of the defect profile match is greater than or equal to a threshold value, the training module 116 may determine that the detected object is a defect and may train a model accordingly. The training module 116 may train the machine learning model by performing the same operation on all remaining cells in the grid and repeating the same stage on the images. The training module 116 may analyze 10,000 image sets in less than four hours, as a non-limiting example.

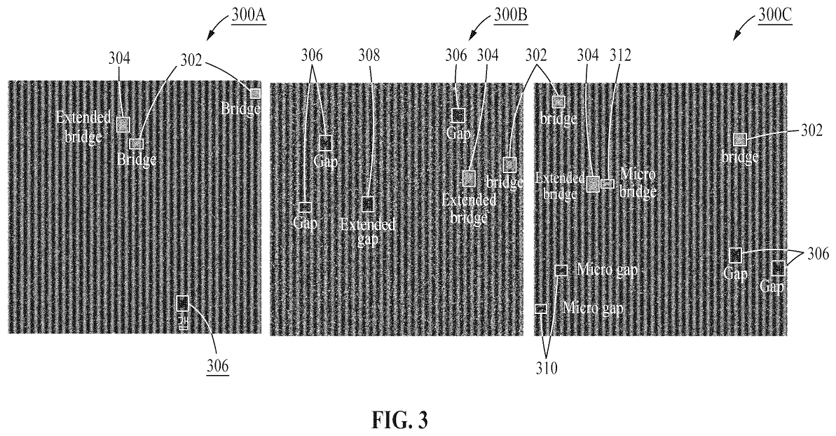

FIG. 3 illustrates an example of a pair of generated images blurred using a gaussian blur in an apparatus.

FIG. 3 illustrates a series of images 300A, 300B, and 300C of the generated images. The training module 116 may identify four defects in the image 300A. Particularly, the training module 116 may identify that the defects are two bridges 302, one extended bridge 304, and a gap 306. Similarly, the training module 116 may identify six defects in the image 300B, the defects including three gaps 306, one bridge 302, one extended bridge 304, and one extended gap 308. In addition, the training module 116 may identify eight defects in the image 300C, the defects including two bridges 302, one extended bridge 304, two gaps 306, two micro gaps 310, and one micro bridge 312. As illustrated, the training module 116 may identify various types of defects and their locations and sizes such that a machine learning model is trained correctly. However, these are only examples, and the training module 116 may identify any number and any type of defects, according to other non-limiting examples.

As stated before, when all images have the same or similar total number of each defect types, the machine learning model may learn how to identify all types of defects equally. When the number of predetermined defect types decreases in the generated images, the machine learning model may not learn those defect types, and hence subsequent detection may not be corrected. Such a technical problem is solved by the apparatus 100 of one or more embodiments. Therefore, the machine learning model trained by the training module 116 may accurately identify defects.

The trained machine learning model may be deployed for image analysis. Referring to FIG. 1, the detection module 118 may use the trained machine learning model to analyze a real image for inference purposes. While operating, the apparatus 100 may receive a real image of a semiconductor wafer captured using an SEM or an optical microscope. When the real image is received, the detection module 118 may implement an image processing technique that divides the real image into a grid. The detection module 118 may then perform object detection on each grid using the trained machine learning model and identify whether there is any defect in each grid. The detection module 118 may accurately detect the number, types, sizes, and locations of defects based on an analysis result.

Hereinafter, a method according to the present disclosure configured as described above will be described with reference to the drawings.

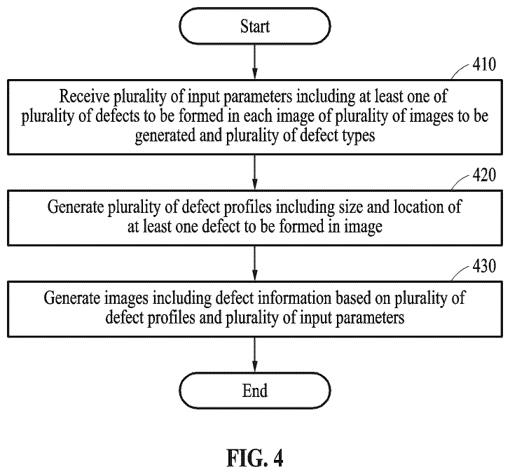

FIG. 4 illustrates an example of a process of generating a plurality of images each having at least one defect in an apparatus.

The order of operations of the method described below should not be construed as a limitation, and the described operations of the method may be combined in any appropriate order to execute the method or an alternative method, and one or more of the operations may be performed simultaneously or in parallel. Furthermore, an individual operation may be eliminated from the method without departing from the spirit and scope of the subject matter described herein.

Referring to FIG. 4, the method of the disclosure may be performed by a programmed computing device (e.g., the apparatus 100), for example, based on instructions retrieved from non-transitory computer-readable media. The computer-readable media may include machine-executable or computer-executable instructions to perform the described method completely or partially. The computer-readable media may be, for example, digital memories, magnetic storage media, such as magnetic disks and magnetic tapes, hard drives, or optically readable data storage media.

In an example, the method of may be performed partially or completely by the apparatus 100 illustrated in FIG. 1. In operation 410, the method may receive input parameters. In an example, the input parameters may be received by the input parameter module 110, and the input parameters may include a plurality of defects to be formed in each image and a plurality of defect types.

In addition, in operation 420, the method may generate a plurality of defect profiles through the annotation module 112. The annotation module 112 may generate defect profiles for images to be generated. Furthermore, the annotation module 112 may determine the size and location of a defect using a random sampling technique to generate the defect profiles.

In operation 430, when the defect profiles are generated, the method may generate the images using the input parameters and the defect profiles through the image generation module 114. The defect profiles of the images may enable the image generation module to introduce defects such that the total number of each defect types remains the same across all images.

A method of identifying a defect in a real image of a semiconductor wafer may recommend/execute a plurality of instructions using images and defect profiles generated using a machine learning model. The processor 102 may perform preprocessing on data to convert the data into data in a form that is suitable for use as an input of the machine learning model. The machine learning model may be obtained through training. Here, “being obtained through training” may refer to obtaining a predefined operation rule or machine learning model that is configured to perform a desired function (or objective) by training a basic machine learning model using a training technique with a plurality of sets of training data. The machine learning model may include a plurality of neural network layers. Each of the plurality of neural network layers may include a plurality of weight values and perform a neural network operation through an operation between operation results.

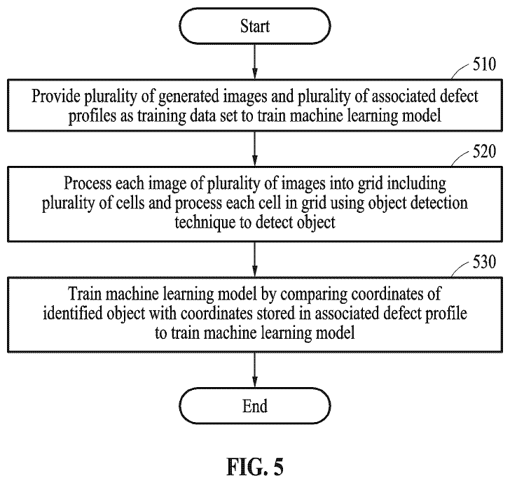

FIG. 5 illustrates an example of a process of training a machine learning model in an apparatus.

Referring to FIG. 5, in operation 510, the method of the disclosure may provide the training module 116 with a plurality of images and a plurality of associated defect profiles generated as a training data set to train a machine learning model.

In addition, in operation 520, the method may process each image of the plurality of images into a grid including a plurality of cells through the training module 116 and identify an object in each cell by processing each cell in the grid using an object detection technique.

Then, in operation 530, the method may compare coordinates of the object identified through the training module 116 with coordinates stored in the associated defect profiles and train the machine learning model by identifying a defect based on the comparison.

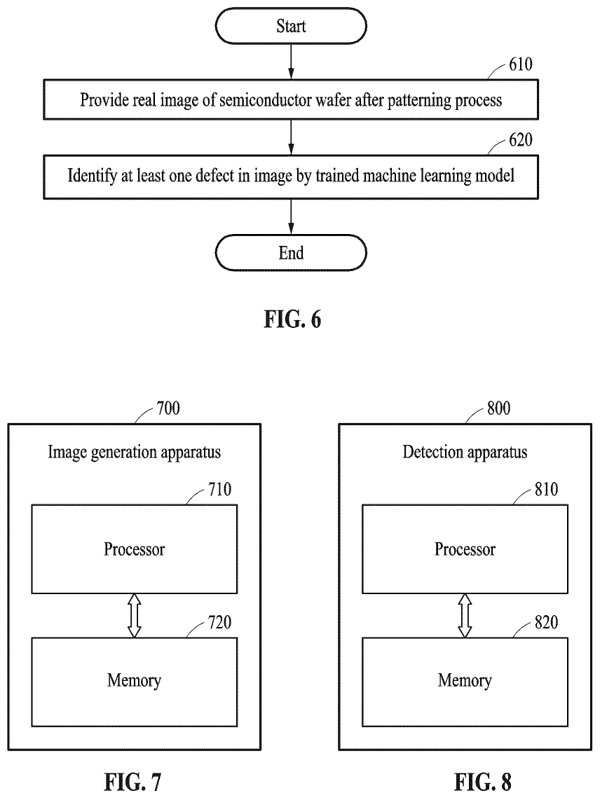

FIG. 6 illustrates an example of a process of identifying a defect in a real image using a trained machine learning model in an apparatus.

Referring to FIG. 6, in operation 610, the method of the disclosure may receive a real image of a semiconductor wafer through the detection module 118 after a patterning process.

Then, in operation 620, the method may identify at least one defect in the real image using a machine learning model trained through the detection module 118. Defect identification may involve determining at least one of a defect type, a defect size, and a defect location in the real image.

Defects are introduced across all images, such that training data prepared using generated images may enable a machine learning model to efficiently and effectively recognize each defect. In addition, since the images are generated, the apparatus 100 may generate a large training data set within a short period of time, thereby reducing the need to collect and annotate real images. Furthermore, the apparatus 100 may be configured to generate an image with a new defect to improve a training data set based on a user's feedback.

FIG. 7 illustrates an example of a schematic configuration of an image generation apparatus for generating an image with a defect.

Referring to FIG. 7, an image generation apparatus 700 may include a processor 710 (e.g., one or more processors) and a memory 720 (e.g., one or more memories).

The processor 710 may receive a plurality of input parameters for a plurality of images to be generated, generate a plurality of defect profiles including the size and location of at least one defect to be formed in the images, and generate the plurality of images including defect information based on the plurality of defect profiles and the plurality of input parameters using an image rendering technique. The input parameters may include at least one of a plurality of defects to be formed in each image and a plurality of defect types. In addition, when generating the plurality of images, the processor 710 may generate the plurality of images, wherein the total number of defects of each type, from among a plurality of defect types, is inserted in equal numbers in the plurality of generated images.

The memory 720 may include any transitory computer-readable medium known to a person skilled in the art including, for example, a volatile memory, such as SRAM and DRAM and/or a non-volatile memory, such as ROM, EEPROM, flash memory, a hard disk, an optical disk, and magnetic tape.

The memory 720 may store an operating system for controlling the overall operation of the image generation apparatus 700, application programs, and data for storage. For example, the memory 720 may be or include a non-transitory computer-readable storage medium storing instructions that, when executed by the processor 710, configure the processor 710 to perform any one, any combination, or all of the operations and methods disclosed herein with reference to FIGS. 1-6. In addition, the memory 720 may store received input parameters, generated defect profiles, and generated images with defects.

FIG. 8 illustrates an example of a schematic configuration of a detection apparatus for training a machine learning model that identifies a defect and detecting a defect using the machine learning model.

Referring to FIG. 8, a detection apparatus 800 may include a processor 810 (e.g., one or more processors) and a memory 820 (e.g., one or more memories).

The processor 810 may provide a plurality of generated images and a plurality of associated defect profiles as a training data set to train a machine learning model, process each image of the plurality of images into a grid including a plurality of cells, identify an object by processing each cell in the grid using an object detection technique, and train the machine learning model by comparing coordinates of the identified object to coordinates stored in the associated defect profiles.

In addition, the processor 810 may provide a real image of a semiconductor wafer after a patterning process and identify at least one defect in the real image by the trained machine learning model.

When identifying the at least one defect in the real image using the trained machine learning model, the processor 810 may determine at least one of a defect type, a defect size, and a defect location in the real image.

The memory 820 may include any transitory computer-readable medium known to a person skilled in the art including, for example, a volatile memory, such as SRAM and DRAM and/or a non-volatile memory, such as ROM, EEPROM, flash memory, a hard disk, an optical disk, and magnetic tape.

The memory 820 may store an operating system for controlling the overall operation of the detection apparatus 800, application programs, and data for storage. For example, the memory 820 may be or include a non-transitory computer-readable storage medium storing instructions that, when executed by the processor 810, configure the processor 810 to perform any one, any combination, or all of the operations and methods disclosed herein with reference to FIGS. 1-6. In addition, the memory 820 may store a generated machine learning model and defect information detected in a received real image.

The apparatuses, processors, memories, modules, data modules, input parameter modules, annotation modules, image generation modules, training modules, detection modules, image generation apparatuses, detection apparatuses, apparatus 100, processor 102, memory 104, module 106, data module 108, input parameter module 110, annotation module 112, image generation module 114, training module 116, detection module 118, image generation apparatus 700, processor 710, memory 720, detection apparatus 800, processor 810, memory 820, and other apparatuses, devices, units, modules, and components disclosed and described herein with respect to FIGS. 1-8 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with image generation, the method comprising:
receiving a plurality of input parameters for a plurality of images to be generated;
generating a plurality of defect profiles comprising a size and location of one or more defects to be formed in an image; and
generating the plurality of images comprising defect information based on the plurality of defect profiles and the plurality of input parameters using an image rendering operation.

2. The method of claim 1, wherein the plurality of input parameters comprises one or more of a plurality of defects to be formed in each image and a plurality of defect types.

3. The method of claim 1, wherein the generating of the plurality of images comprises generating the plurality of images such that a total number of defects of each type, from among a plurality of defect types, is inserted in equal numbers in the plurality of generated images.

4. The method of claim 1, wherein each of the plurality of generated images comprises a line pattern corresponding to either one of an optical microscopy image and a scanning electron microscope image of a patterning process.

5. The method of claim 4, wherein one or more defects of the line pattern comprises any one or any combination of any two or more of a micro bridge, a bridge, a micro gap, an extended gap, and a line-collapse.

6. The method of claim 1, wherein the generating of the plurality of defect profiles comprises determining the location and size of the one or more defects to be formed in each image to be formed using a random distribution operation.

7. The method of claim 1, further comprising:
providing the plurality of generated images and the plurality of generated defect profiles as a training data set to train a machine learning model;
processing each image of the plurality of images into a grid comprising a plurality of cells;
identifying an object by processing each cell in the grid using an object detection operation; and
training the machine learning model by comparing coordinates of the identified object with coordinates stored in the plurality of generated defect profiles.

8. The method of claim 7, further comprising:
providing a real image of a semiconductor wafer after a patterning process; and
identifying the one or more defects in the real image using the trained machine learning model.

9. The method of claim 8, wherein the identifying of the one or more defects in the real image using the trained machine learning model comprises determining any one or any combination of any two or more of a defect type, a defect size, and a defect location in the real image.

10. A non-transitory computer-readable storage medium storing instructions that, when executed by one or more processors, configure the one or more processors to perform the method of claim 1.

11. An apparatus with image generation, the apparatus comprising:
one or more processors configured to:
receive a plurality of input parameters for a plurality of images to be generated;
generate a plurality of defect profiles comprising a size and location of one or more defects to be formed in an image; and
generate the plurality of images comprising defect information based on the plurality of defect profiles and the plurality of input parameters using an image rendering operation.

12. The apparatus of claim 11, wherein the plurality of input parameters comprises one or more of a plurality of defects to be formed in each image and a plurality of defect types.

13. The apparatus of claim 11, wherein for the generating of the plurality of images, the one or more processors are configured to generate the plurality of images such that a total number of defects of each type, from among a plurality of defect types, is inserted in equal numbers in the plurality of generated images.

14. The apparatus of claim 11, wherein each of the plurality of generated images comprises a line pattern corresponding to either one of an optical microscopy image and a scanning electron microscope image of a patterning process.

15. The apparatus of claim 14, wherein one or more defects of the line pattern comprises any one or any combination of any two or more of a micro bridge, a bridge, a micro gap, an extended gap, and a line-collapse.

16. The apparatus of claim 11, wherein, for the generating of the plurality of defect profiles, the one or more processors are configured to determine the location and size of the one or more defects to be formed in each image to be formed using a random distribution operation.

17. The apparatus of claim 11, wherein the one or more processors are configured to:
receive the plurality of generated images and the plurality of generated defect profiles as a training data set to train a machine learning model;
process each image of the plurality of images into a grid comprising a plurality of cells;
identify an object by processing each cell in the grid using an object detection operation; and
train the machine learning model by comparing coordinates of the identified object with coordinates stored in the plurality of generated defect profiles.

18. The apparatus of claim 17, wherein the one or more processors are configured to:
receive a real image of a semiconductor wafer after a patterning process; and
identify the one or more defects in the real image using the trained machine learning model.

19. The apparatus of claim 18, wherein, for the identifying of the one or more defects in the real image using the trained machine learning model, the one or more processors are configured to determine any one or any combination of any two or more of a defect type, a defect size, and a defect location in the real image.

20. A processor-implemented method with image generation, the method comprising:
processing each of a plurality of generated images into a grid comprising a plurality of cells, wherein the plurality of images are generated based on a plurality of defect profiles and a plurality of input parameters using an image rendering operation;
identifying an object by processing each cell in the grid using an object detection operation; and
training a machine learning model by comparing coordinates of the identified object with coordinates stored in the plurality of defect profiles.
